(19) United States
(12) Patent Application Publication
(10) Pub. No.: US 2002/0038165 A1
(43) Pub. Date: Mar. 28, 2002

(54) System and method for serving patrons of restaurants and bars

(76) Inventors: John T. McHale IV, St. Louis, MO (US); Jerome Katz, St. Louis, MO (US)

Correspondence Address: Benjamin L. Volk, Jr., HOWELL & HAFERKAMP, L.C., Suite 1400, 7733 Forsyth Boulevard, St. Louis, MO, 63105, US

(21) Appl. No.: 09/993,243

(22) Filed: Nov. 6, 2001

Related U.S. Application Data
(63) Continuation-in-part of application No. 09/613,117, filed on Jul. 10, 2000.

(51) Int. Cl. G06F 7/00

(52) U.S. Cl. 700/216

(57) ABSTRACT

A computerized system and method for processing an order for food and/or drink without requiring a waiter or waitress to take the order is improved by incorporating an advertising scheme into the system whereby advertisements are selected by an establishment server having a customized data base, said selection being based on any combination of various parameters, such as patron identity, ordered menu items, time of day, etc. and then communicated to the interactive stations from which patrons enter their orders for electronic display thereon. A plurality of establishment servers may be connected to a central server and the central server may control the entirety of the advertising process by selecting the ads to be stored in each establishment server data base as well as the parameters governing the selection process.

### CROSS REFERENCE TO RELATED APPLICATION

This application is a continuation-in-part of U.S. patent application Ser. No. 09/613,117, filed Jul. 10, 2000 entitled “Beverage Delivery System”, the entire disclosure of which is hereby incorporated by reference.

### FIELD OF THE INVENTION

The present invention relates to systems and methods for serving patrons of restaurants, bars, and the like (collectively referred to herein as “establishments”).

### BACKGROUND OF THE INVENTION

According to statistics, there are approximately 800,000 bars and restaurants currently operating in the United States, generating $250 billion in revenue, and representing approximately 4% of the gross domestic product for the U.S. Studies indicate that these numbers will continue to grow over the next several years. However, while the restaurant/bar industry is extensive, it suffers from notoriously tight profit margins: roughly four to five percent. Thus, there has been a constant need in the restaurant industry for the ability of establishment owners to not only attract new patrons, but also decrease overhead while still providing high quality service to patrons.

The quality of service provided to patrons of an establishment can be of critical importance to the success of an establishment. The perceived promptness and quality of service provided by establishment personnel (servers, bartenders, seaters, etc.) often affect the amount of repeat business and new business experienced by an establishment. Important factors affecting the quality of service provided to patrons are prompt service from establishment personnel and the uniqueness of the restaurant experience (i.e. ambience, unique services). It is also important that a restaurant be able to achieve fast table turnaround to thereby generate maximum revenue during peak business hours (prompt service also being an important factor in achieving such fast table turnaround).

Unfortunately, most establishment owners have found it difficult to find, train, and maintain productive employees capable of providing such prompt but attentive service while still increasing, or at least maintaining, their profit margins. Further, regardless of the skill of the establishment staff, the conventional process of serving tables can be highly inefficient. The conventional serving process entails a waiter or waitress walking to each table to take orders from patrons (which may require separate trips to each table for drink, appetizer, entree, and dessert orders), communicating each order to the appropriate personnel for fulfillment (i.e., letting the cook know what the food order is), periodically monitoring whether the order is ready to be brought to a table, physically bringing each order to each table, periodically checking each table to determine whether additional service is needed (i.e., a drink refill), and then delivering and collecting a bill when each patron is done.

Over the years, as competition has intensified, establishment owners have increasingly looked toward the effective use of technology as a way to improve the viability of their businesses. Toward this end, many ideas have been proposed in an attempt to use new technology to improve the conventional serving process.

For example, in U.S. Pat. No. 4,553,222 issued to Kurland et al. (the disclosure of which is hereby incorporated by reference), an integrated interactive restaurant communication system for food and entertainment processing is disclosed. In this system, a plurality of table stations are provided in an establishment. Each table station is an “intelligent” terminal having a video monitor from which a patron may view menu items and place orders therefor. Each table station is linked to a central computer which provides centralized processing for the orders received by each of the table stations. The system effectively functions as an establishment-wide private local area network (LAN). The system supports interactive entertainment activities (such as video games) which can be provided at each of the table stations for play by patrons as they await fulfillment of their orders. The system also supports automated tracking of the bill, as well as the printing of a receipt at each table station. As a result, Kurland discloses a system that improves the efficiency of service provided to patrons of an. establishment because patrons have the ability to directly place their orders without having to wait for the waiter/waitress to come to their tables and then communicate each order to the cook. U.S. Pat. No. 5,262,938 issued to Rapoport et al. (the disclosure of which is hereby incorporated by reference) discloses a similar system directed toward a streamlined patron service system.

Another example is found in U.S. Pat. No. 5,845,263 issued to Camaisa et al. (the disclosure of which is hereby incorporated by reference), which discloses an interactive visual ordering system. The Camaisa system, which expands upon the basic ideas of the Kurland system, provides the added features of (1) displaying a realistic image of each food item to thereby allow a patron to know what he/she is ordering, and (2) displaying nutritional information for each food item to thereby allow health-conscious patrons to make informed selections. Camaisa also discloses that the system can be connected to a wide area network (WAN) to thereby support remote orders from people's home computers.

While each of these examples represents an improvement over the inefficient conventional serving process, they have failed to become widely implemented in the restaurants and bars of this country. The inventors herein believe that these prior art systems have failed to become popular due to their inability to substantially improve an establishment's profit margins. With such prior art systems, it is believed that the expected manpower/table turnaround/patron interest improvements provided by such systems do not sufficiently offset the capital investment of system purchase/leasing and installation to justify their implementation. Given this situation, a strong need in the art exists for an improvement to the systems of the prior art to make them economically feasible.

### SUMMARY OF THE INVENTION

In an effort to make interactive ordering systems economically feasible, the inventor herein has expanded upon the ideas first disclosed in the parent application (U.S. patent application Ser. No. 09/613,117, filed Jul. 10, 2000 entitled “Beverage Delivery System”). In the parent application, a beverage delivery system is disclosed which allows a patron to pour his/her own drink order directly from a station at his/her table without the intervention of a server or bartender. A display screen within each of the stations displays the beverage ordered and the amount of beverage dispensed. As part of this invention, the inventor discloses that the system can be in communication with a global computer network such as the Internet. Through this network connection, the system can electronically present on each display screen information such as advertisements, news, images, e-mail, web pages, and other various types of useful information to patrons using the system.

In the present invention, the idea of bringing advertising to patrons of an establishment has been developed into an integrated system allowing an advertiser to flexibly target its advertisements to patrons of establishments with an interactive patron service system having at least one patron station with a display on which images can be shown. The inventor herein believes that by implementing an advertising scheme on an interactive patron service system, such systems will become economically feasible because they will no longer add to the overhead of an establishment but rather generate income in and of themselves through advertising revenue.

Each establishment implementing the present invention will have at least one patron station located therein (preferably a plurality of patron stations). From each patron station, patrons can view a plurality of selectable menu items that are electronically shown on a display of the patron station. Each patron station will also be configured to electronically display at least one advertisement on its display. Each patron station will also be configured to receive order input that corresponds to an order of at least one menu item shown on the patron station display. For example, the patron station display may be a touchscreen LCD which allows a patron to select a menu item by touching an image shown on the touchscreen relating to that menu item.

Each patron station located in an establishment is connected to an establishment server associated with that establishment. The establishment server coordinates the operation of each patron station connected thereto. The establishment server will receive and process order input received by a patron station to thereby enable fulfillment of the order.

Preferably, the establishment server has stored thereon a plurality of advertisements. Under software control, the establishment server can communicate at least one of these stored advertisements to the patrons stations connected thereto. The software used to control the distribution of advertisements (referred to herein as an “advertisement selection program”) provides a wide degree of flexibility, thereby allowing a practitioner of the present invention to tailor the invention such that virtually any advertising scheme desired by an advertiser can be implemented. By appropriately designing the software, each establishment server can deliver different advertisements to different patron stations in response to a variety of predetermined conditions (including, but not limited to order content, patron identity, time of day, etc). For example, when a particular patron station receives order input corresponding to an order of chicken wings, the software can be designed such that the establishment server will select a beer advertisement to be sent to that particular patron station for display thereon. At the same time, another patron station may receive order input corresponding to an order of a steak. The software can be designed to select an advertisement for the local butcher shop for display on that patron station.

Preferably, the establishment server is also connected to a network from which it receives the plurality of advertisements stored thereon from a central server that is also connected to the network. The central server can also communicate over the network to the establishment server the advertisement selection program (or at least portions thereof) for storage and subsequent execution thereon.

The central server can preferably act as an administrative center for the distribution of advertisements. A plurality of establishment servers can preferably be in communication with the central server via the network. Each establishment server will preferably be associated with at least one establishment and will preferably be connected to at least one patron station located in the associated establishment. In this embodiment, by appropriately tailoring the particular advertisements and the particular advertisement selection program sent to each establishment server, advertisers can use the present invention as a national, even global, advertising network capable of targeting specific advertisements to particular niche audiences.

For example, a music company selling compact discs for a variety of musical artists in a wide range of musical genres can implement an effective advertising scheme at low cost for its products by selecting which types of patrons should receive which ads: an advertisement for a CD featuring country music can be sent to an establishment server associated with an establishment that caters to patrons who would be expected to listen to country music (i.e. a country-western bar); a CD featuring dance music can be sent to an establishment server associated with an establishment that caters to patrons who would be expected to listen to dance music (i.e. a college bar).

Another feature of the invention is the ability to deliver additional advertising information to patrons who have expressed an interest in a particular advertisement. Upon receiving input from a patron station corresponding to a selection by a patron of a particular advertisement, an establishment server can either (1) link that patron station to a web site associated with the advertisement via the network connection, (2) cause the patron station to display an advertisement supplement associated with the selected ad, or (3) cause the patron station to display an enlarged version of the selected ad.

Further, the present invention provides the ability to collect a wide range of demographic information useful to advertisers in determining marketing schemes. The demographic information can encompass a relatively narrow range of information (an identification of what foods/drinks are popular at a particular establishment) to wider ranges of information (specifically identifying particular patrons and their ordering habits, what ads are shown to them, and personal information such as age, gender, race, etc.). Each establishment server can collect and store such demographic information for submission over the network to the central server. Smart card technology can be used in conjunction with the present invention to collect and store demographic information.

The system can also use such demographic information and patron identity date to develop a customized “favorites menu” for each patron known to the system. Menu items commonly ordered by a particular patron can be determined from the establishment server's records and presented to that patron on a subsequent visit. Further still, the central server can be used to make such patron identity data available to all establishment servers and not just the establishment server connected to the patron station at which that patron registered himself/herself.

Also, the establishment server can be used for inventory tracking purposes. As orders are placed, the establishment server can compare the order data with stored data relating to an establishment's supply of various menu items. For example, if a bar stocks 5 cases of a particular type of beer, the establishment server can be used to track the order input received by each patron station to which it is connected and determine whether the supply of that type of beer is being depleted to the point where a new shipment is needed. Further still, the establishment server can be used to place an order for a new shipment of a menu item over the network to a computer system under the control of the supplier of that menu item, to thereby initiate a request for an additional amount of that menu item.

Moreover, the present invention can be integrated with a music playing device having a plurality of selectable music items (i.e. a jukebox) to allow a patron to select a music item (i.e. a song) that he/she wishes to hear from the patron station, without requiring the patron to walk to the jukebox and enter a music selection thereat. Any charges associated with the music item selection can be added to the patron's tab. Further still, particular advertisements can be sent to particular patron stations in response to the music selections entered into the patron station by a patron.

In delivering advertisements to the patrons of establishments implementing an integrated interactive patron service system, the present invention can succeed where the prior art has failed. By combining the interests of advertisers with establishment owners, a synergistic union is created which provides advertisers with a powerful tool for reaching valuable potential customers and provides establishment owners with not only a system that can improve the efficiency of service provided to patrons, but also provides a new income stream through advertising revenues as well as a unique interactive experience that can attract new patrons to such establishments.

These and other features and advantages of the present invention will be in part disclosed and in part apparent upon reference to the drawings and text herein.

### BRIEF DESCRIPTION OF THE DRAWINGS

FIG. 1 depicts a block diagram overview of the present invention showing the relationships between the central server, establishment servers, and patron stations;

FIG. 2 depicts a block diagram flowchart for the advertisement distribution of the present invention;

FIG. 3 depicts a block diagram of a station used in the system of the present invention;

FIG. 4 depicts a block diagram of an establishment server used in the system of the present invention;

FIG. 5 depicts a block diagram of a central server used in the system of the present invention;

FIG. 6 depicts an example of a rule set that can be used in designing an advertisement selection program;

FIG. 7a is a flowchart showing the seating process;

FIG. 7b is a flowchart showing the patron station startup process;

FIG. 7c is a flowchart showing the new patron registration process;

FIG. 7d is a flowchart showing the registered patron login process;

FIG. 7e is a flowchart showing menu display process;

FIG. 7f is a flowchart showing the menu item selection process;

FIG. 7g is a flowchart showing the order customization process;

FIG. 7h is a flowchart showing the order viewing process;

FIG. 7i is a flowchart showing how a separate order can be initiated;

FIG. 7j is a flowchart showing the order submission process;

FIG. 7k is a flowchart showing how orders are processed;

FIG. 7l is a flowchart showing further how orders are processed;

FIG. 7m is a flowchart showing the bill preparation process;

FIG. 7n is a flowchart showing the bill payment process;

FIG. 7o is a flowchart showing how orders are closed;

FIG. 7p is a flowchart showing the system's response to ad selection by patrons;

FIG. 8 is an illustration of selectable icons shown on the patron station display;

FIG. 9 is another illustration of selectable icons shown on the patron station display;

FIG. 10 is a block diagram showing the integration of the system with a music playing device;

FIG. 11 is a flowchart showing how song requests are processed;

FIG. 12 is a block diagram flowchart illustrating how demographic information is collected by the central server; and

FIG. 13 is a block diagram flowchart illustrating the inventory tracking aspect of the invention.

### DETAILED DESCRIPTION OF THE PREFERRED EMBODIMENT

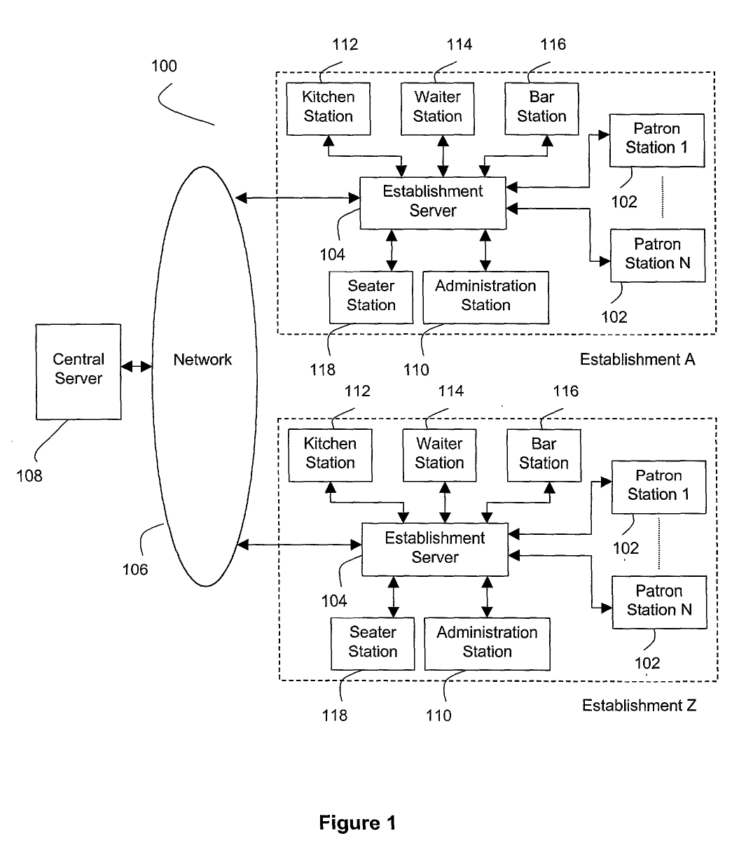

FIG. 1 illustrates a preferred embodiment 100 of the present invention. In FIG. 1, each establishment has a plurality of patron stations 102 located therein. FIG. 1 depicts Establishments A and Z, but it should be understood that the present invention can be implemented in a single establishment or a large number of establishments. It should also be understood that each establishment may have only one patron station 102 located therein, although it is preferred that several patron stations 102 be located in each establishment to ensure wider use of the invention.

Each patron station 102 serves as an interactive portal from which a patron (or several patrons) may directly place orders without waiter/waitress intervention. Preferably, each patron station 102 is located at a table in the establishment.

The establishment server 104 acts as the control center for the establishment's operations. The primary tasks assigned to each establishment server are (1) processing the order input received by the patron stations 102 to which it is connected, (2) storing the advertisements to be displayed on the patron stations 102, and (3) determining which advertisements are to be communicated to which patron stations 102 for display thereon.

The central server 108 acts as the control center for advertising. Preferably, the central server is a central repository for all advertisements used by the system 100. The central server 108 will also preferably store the software used by the establishment servers to determine how advertisements are to be distributed to the patron stations (referred to herein as an “advertisement selection program” or ASP). By way of its connection to network 106, the central server 108 sends to each establishment server 104 the advertisements and ASP assigned thereto. Because the ASP governs how advertisements are shown on the patron stations, the design of the ASP will be of importance to the advertisers who pay to have their advertisements shown on the patron stations.

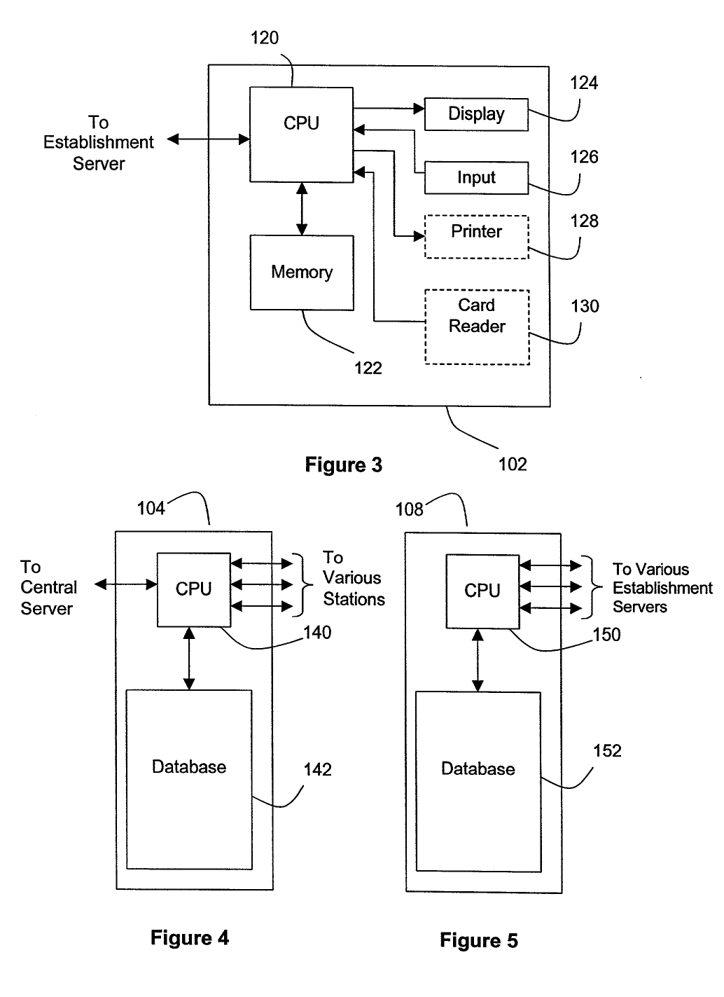

Referring to FIG. 3, each patron station 102 has a display 124 on which patrons can view the establishment's food and drink selections (referred to herein as “menu items”) as well as an input 126 which allows each patron to enter his/her order. In addition to the menu items, each patron station 102 also electronically displays advertisements on display 124.

Preferably the display 124 and input device 126 are integrated in one unit in the form of a touchscreen LCD which allows a patron to enter input corresponding to a selection of a displayed item by touching an icon shown on the touchscreen relating to that item. The use of a touchscreen LCD eliminates a need to provide a separate input device such as a mouse or keyboard which may become damaged or inconvenient to use in the restaurant/bar setting. An exemplary touchscreen LCD suitable for use with the present invention is the MultiSync LCD 2010X-T having a 20.1 inch viewable image size manufactured by NEC USA, Inc. of Melville, N.Y. However, it should be noted that any compatible input device or display can be used in the practice of the present invention.

A CPU 120 processes input received from patrons and data to be displayed on the display 124. Memory 122 stores identification data for the patron station, such as the table number at which the patron station is located. Memory 122 may also store other identification variables useful for processing orders (i.e. an order number, a patron number), as will be explained below.

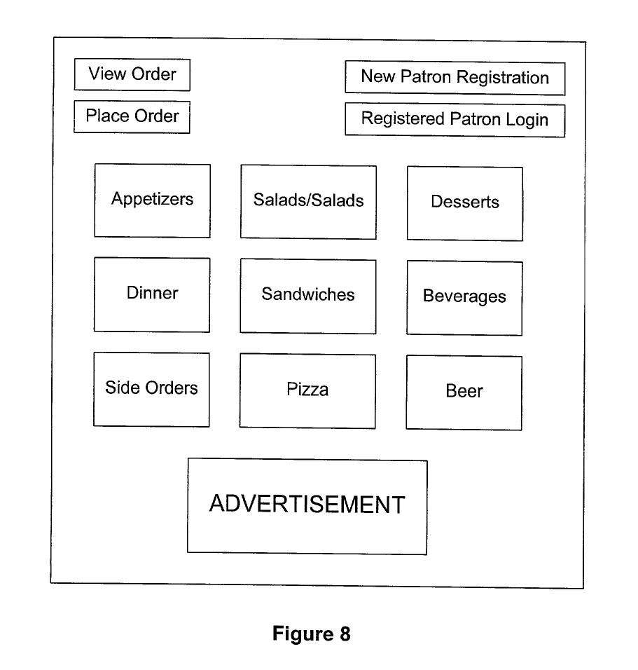

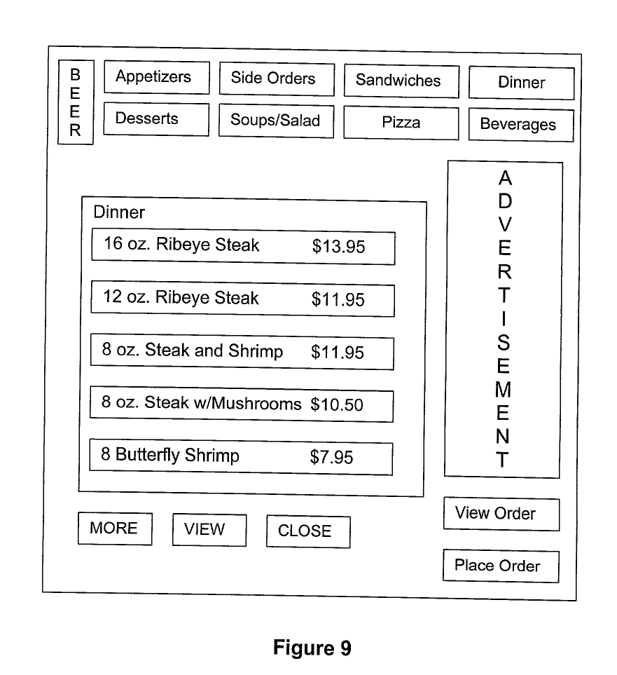

Examples of display screens that can be used in the practice of the present invention are shown in FIGS. 8 and 9. The boxes shown in FIGS. 8 and 9 represent icons that can be selected by a patron in entering an order. For example, FIG. 8 shows several icons related to different categories of items that a patron may order. FIG. 9 shows several specific menu items classified under the category “dinner”. Both FIGS. 8 and 9 illustrate how advertising can be brought to a patron's attention; large advertising icons are shown in both figures. However, it must be noted that the menu-related icons need not be shown simultaneously with an advertisement icon. For example, the display can alternate periodically between an advertisement screen and a menu item screen.

It is preferable that each patron station 102 effectively function as an input/output device for the establishment server 104. The primary tasks assigned to the patron station are to (1) pass input to the establishment server 104 and (2) display menu icons and advertisements received from the establishment server. Preferably, virtually all substantive processing of the input received by the patron station is performed by the establishment server 104. A browser application (such as Internet Explorer from the Microsoft Corp. of Redmond, Wash.) can be run on the patron station in conjunction with a flash plug-in to display the data provided to the patron station by the establishment server. As would be recognized by one of ordinary skill in the art, rather than using a browser in conjunction with a flash plug-in, the patron stations may use a stand-alone flash application, for example Macromedia Flash from Macromedia, Inc. of San Francisco, Calif. Further still, the data from the establishment server may also be run like an MP3 file, which would require a suitable external player. Suitable hardware for the CPU 120 and memory 122 is a Dell Optiplex GX240 Small Form Factor SF Chassis from Dell Computer Corp. of Round Rock, Tex. An example of a suitable standalone patron station, wherein the touchscreen, CPU, and memory are integrated as one unit, is a Protouch 2000 manufactured by Protouch Manufacturing Ltd. of Surrey, United Kingdom.

Optional features for the patron station 102 include a printer 128 and a card reader 130 in communication with the CPU 120. Together, the card reader 130 and printer 128 can allow a patron to directly pay his/her tab without requiring waiter/waitress intervention. When the tab is ready to be paid, a patron can operate the patron station such that the bill is shown. Thereafter, the patron can swipe a credit card through the reader 130, and the printer can print a receipt for the patron.

Returning to FIG. 1, the establishment server 104 is connected to each patron station 102 located in the establishment. The connections between the establishment server 104 and patron stations 102 are preferably wireless connections, thereby providing portability of the various patron stations within the establishment in the event tables are moved. However, any mode of connection sufficient to allow data exchange between the establishment server and patron station can be used (cables, etc).

As stated, the establishment server 104 acts as a control center for that establishment's electronic service system. The establishment server 104 provides each patron station to which it is connected with the data needed for the patron stations to display various menu items and advertisements. The establishment server 104 will also make decisions as to which advertisements are provided to which patron stations as well as process the food/drink orders received by the patron stations.

Preferably, the establishment server stores the advertisements that are to be displayed on the patron stations as well as an advertisement selection program (ASP) used by the establishment server to select which ads are to be displayed. The ASP can be configured to take a variety of predetermined conditions into account when choosing which advertisements are to be distributed to the patron stations. For example, the ASP can select a particular ad in response to any or all of the following factors: time of day (happy hour? lunch crowd? dinner crowd? late night crowd?), patron identity (allows advertisements to be targeted to specific people), and order content (present a cigarette ad to a beer drinker, present a beer ad to a person who has just ordered an appetizer, etc). Through the appropriate design of the ASP, virtually any advertising scheme can be implemented using the present invention.

Preferably, each establishment server 104 is connected to a network 106. The network is preferably the Internet, but can also be a private LAN, private WAN or any suitable network allowing the exchange of data between the central server 108 and establishment servers 104. FIG. 4 depicts a block diagram of the establishment server. A CPU 140 is interfaced with a database 142 as well as the central server 108 (by way of network 106) and the various stations to which it is connected.

The database 142 stores virtually all data used by the establishment in processing orders and delivering advertisements. Stored in the database 142 will be the plurality of advertisements eligible to be shown on the patron station displays 124, the ASP executed by the CPU 140 to thereby determine which ads are to be shown, files detailing the contents and status of the orders placed by patrons, files detailing the past orders and ad selection history of registered patrons, a log identifying when and how often each advertisement is displayed or selected by a patron, as well as any other data the establishment server may gather. Suitable hardware for the establishment server 104 is a Dell PowerEdge 500SC also manufactured by Dell Computer Corp.

The central server 108 is also preferably connected to the network 106. As stated, the central server 108 acts as a control center for the advertising aspect of the present invention. The central server 108 is preferably a repository of all advertisements and ASPs to be used by each establishment server 104 included in the system 100. Referring to FIG. 5, database 152 will store the ads and ASPs while CPU 150 coordinates the distribution of ads and ASPs to the various establishment servers 104. Suitable hardware for the central server 108 is Dell Computer Corp.'s Dell PowerEdge 2500.

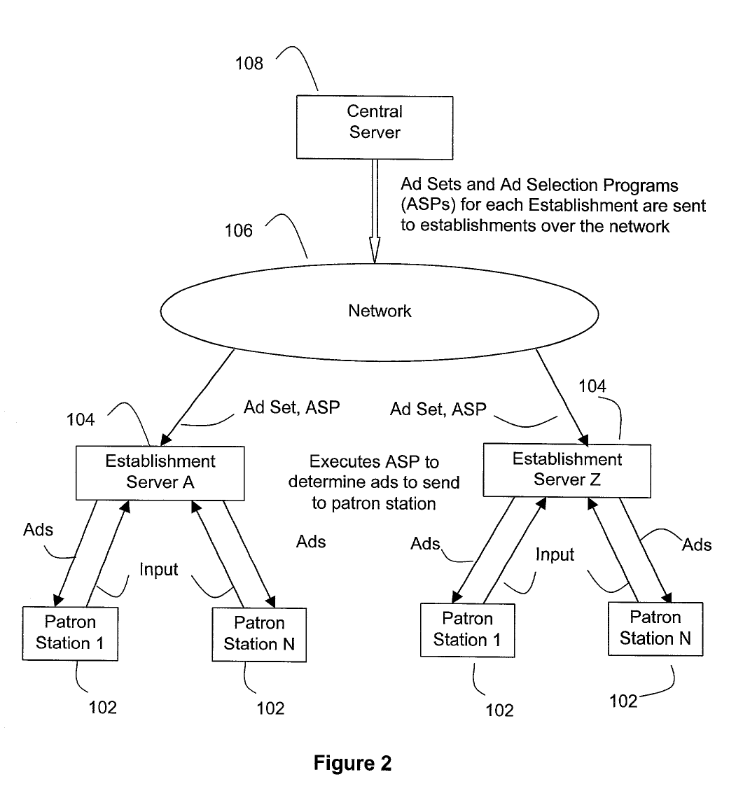

FIG. 2 illustrates the advertisement distribution aspect of the invention. Each establishment will have a designated set of advertisements eligible for display on the patron stations located in that establishment. Each establishment will also have a designated ASP containing the rules for how that establishment is to display the ads included in that establishment's advertisement set. The central server 108 will send the appropriate advertisement set and ASP to each establishment server 104 over the network 106. Also, rather than sending the entire ASP to each establishment server, the central server may send portions of the ASP to each establishment server. For example, each establishment server may already have stored thereon the framework of the ASP, and may only receive pertinent parameters to be plugged into that framework which correspond to the rules governing the ad selection process. Once in receipt of its ad set and ASP, each establishment server 104 can begin executing the ASP to determine which ads are to be displayed. Depending upon the design of the ASP, the establishment server may determine which ads to provide to which patron stations at least partially in response to the input received by the patron stations.

By centralizing the advertising network with the central server 108, a practitioner of the present invention, preferably in partnership with advertisers, can develop advertising schemes that are highly effective at reaching an advertiser's desired demographic group. A practitioner of the present invention can then sell advertising rights to different advertisers. Thus, a beer company who wishes to develop product recognition in an untapped market can purchase advertising rights allowing it to send its advertisements to various bars in that untapped market. For example, assume Beer Company X would like to expand into the St. Louis market. To generate brand recognition among consumers in St. Louis, Beer Company X can purchase advertising rights from a practitioner of the present invention. The practitioner of the present invention can then configure the ASPs associated with bars and restaurants located in St. Louis such that Beer Company X's advertisements will be shown in a variety of circumstances. After loading Beer Company X's advertisements onto the central server and appropriately modifying the ASPs for the St. Louis establishment to take into account Beer Company X's ads, those ads and the modified ASPs can be sent over the network 106 to the establishment servers of any or all of the restaurants and bars in the St. Louis area using the present invention.

In the event a new advertiser signs on, an advertiser wishes to change its ads, or some other situation requiring a modification of the system, those changes can be instituted on the central server 106, and updated ad sets and/or ASPs (or portions of ASPs) can be sent to the affected establishment servers 104. This aspect of the invention further enhances the flexibility that the system provides to advertisers.

Returning to FIG. 1, each establishment preferably also has a number of staff-related stations located throughout the establishment. For example, a kitchen station 112 connected to the establishment server 104 can be used to provide a display on which cooks and food preparation personnel can view the orders that need to be prepared. The establishment server 104 can route the appropriate data to the kitchen station 112 needed to display such information.

Similarly, a waiter station 114 can be used to provide a display on which waiters and waitresses can learn of the orders placed by patrons. By monitoring the waiter station 114, waiters and waitresses will know when and where prepared orders are to brought to the tables.

A bar station 116 can be used to provide a similar service to bartenders. If a patron at table XYZ has ordered a gin and tonic from the patron station located at his table, the bar station 116 will receive this order by way of the establishment server and then display the gin and tonic order to thereby inform the bartender that he needs to make a gin and tonic.

A seater station 118 can be used by personnel at the establishment in charge of seating newly arrived patrons at tables. The seater can enter information into the seater station identifying which tables are occupied. Upon communication of this data to the establishment server, the establishment server can track each table's status (is the table occupied? if so, for how long? etc). Then, a table status report can be sent back to the seater station 118 and displayed thereon to thereby allow the seater to make informed decisions as to where new patrons need to be seated or how long a patron may have to wait before a table becomes available.

Further, the present invention may include an administrative station 110 connected to the establishment server. The administration station can be interfaced with the establishment server such that authorized personnel (i.e., an establishment owner or manager) can access the records stored on the establishment server and possibly modify some of the system's settings. For example, the administration station may be configured to allow an authorized person to modify the menu items shown on the system, such as by adding new menu items, deleting menu items no longer available, and altering menu item prices.

Each station 110, 112, 114, 116, or 118 will share similar architecture as the patron station 102 shown in FIG. 2. Depending upon the tasks assigned to the station, input 126, printer 128, or card reader 130 may or may not be needed. For example, the kitchen station 112 presumably would not need a printer 128 or credit card reader 130 because the kitchen station would not need to support receipt printing or bill payment.

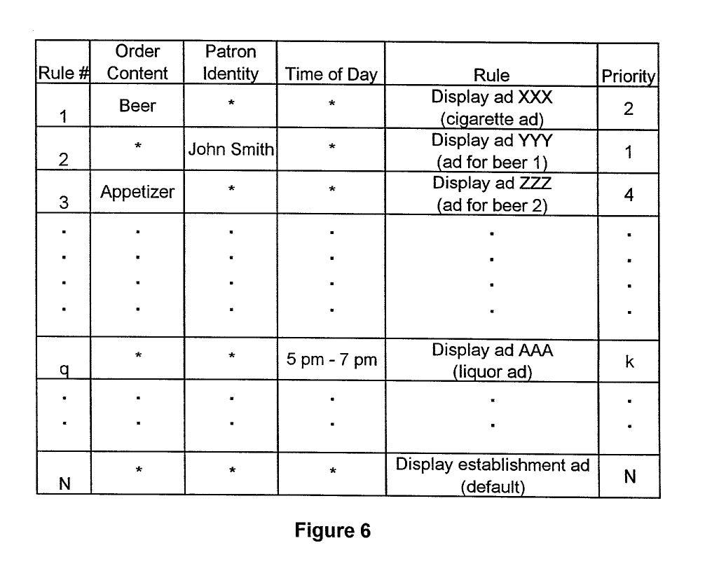

FIG. 6 illustrates a plurality of rules that can be implemented in the ASP to determine which ads to select for display. With an appropriately designed ASP, an advertiser has at its disposal a powerful tool for implementing an effective advertising campaign that targets a specific audience. It is preferred that the ASP be implemented in software to allow portability and flexibility to modifications.

In the example of FIG. 6, three predetermined conditions are used in the decision-making process: order content, patron identity, and time of day. However, any condition ascertainable by the establishment server can be used as a factor in selecting which ads are to be displayed. Each condition has an associated rule identifying the ad to be selected when the condition is met. Also, each rule has an assigned priority which can be used to choose which rule is to be selected when a condition matches more than one rule. The asterisk in the condition columns of FIG. 6 is used to indicate a “don't care” situation.

For example, if John Smith registers himself at a patron station and orders a beer, rules 1, 2, and N will have their conditions satisfied. The order content will be beer (which satisfies the conditions of rule 1), the patron identity will be John Smith (which satisfies the conditions of rule 2), and rule N is a default rule in which all conditions are don't cares (used to prevent a situation where no rule is applicable). Because rule 2 has the highest priority assigned thereto, the ASP will select rule 1 and display ad YYY.

Of course, the ASP could be configured to display all matching rules, with the higher priority ads being given a more prominent position on the patron station display or a longer display duration.

Returning to the example of FIG. 6, if an unknown patron arrives at the establishment for happy hour (say at 6 pm) and orders a hamburger, the matching rule for that condition will be rule q because the time of day is between 5 pm and 7 pm. Under such conditions, the ASP will select ad AAA. Also, if that same patron orders an appetizer two hours later, the conditions of rule 3 will be satisfied, thereby prompting the display of ad ZZZ.

A suitable software platform for the ASP is Microsoft's Internet Information Server. However, programmers of ordinary skill in the art will readily recognize a wide variety of specific ways to implement the concepts disclosed in the present invention, particularly FIG. 6, and as such, the present invention is not to be limited to any specific software code.

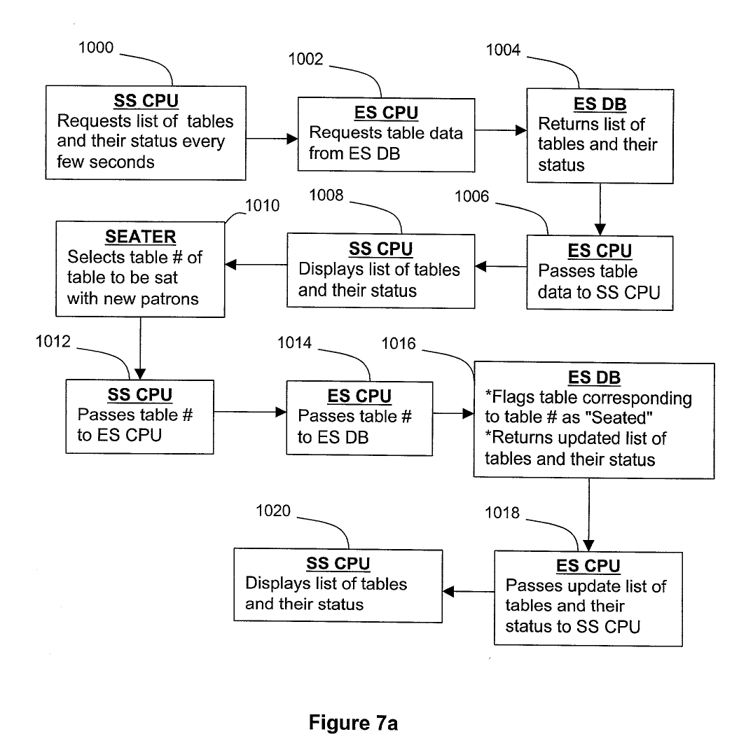

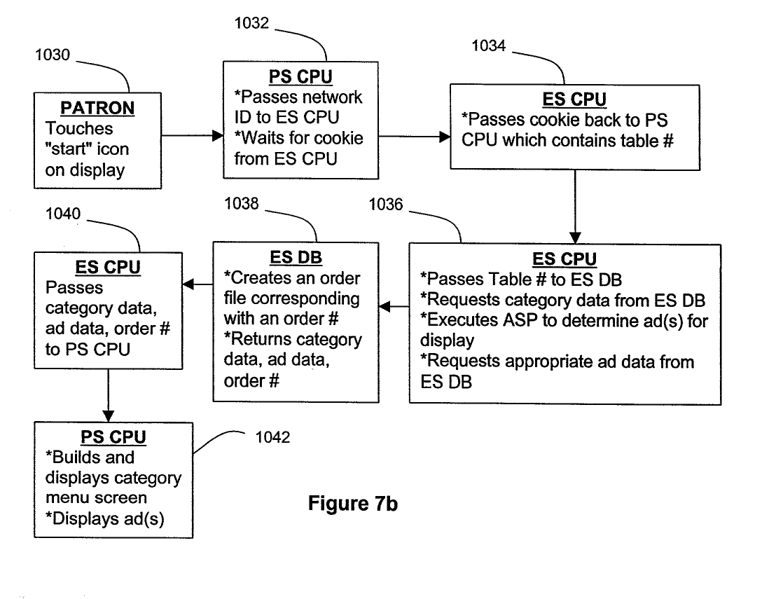

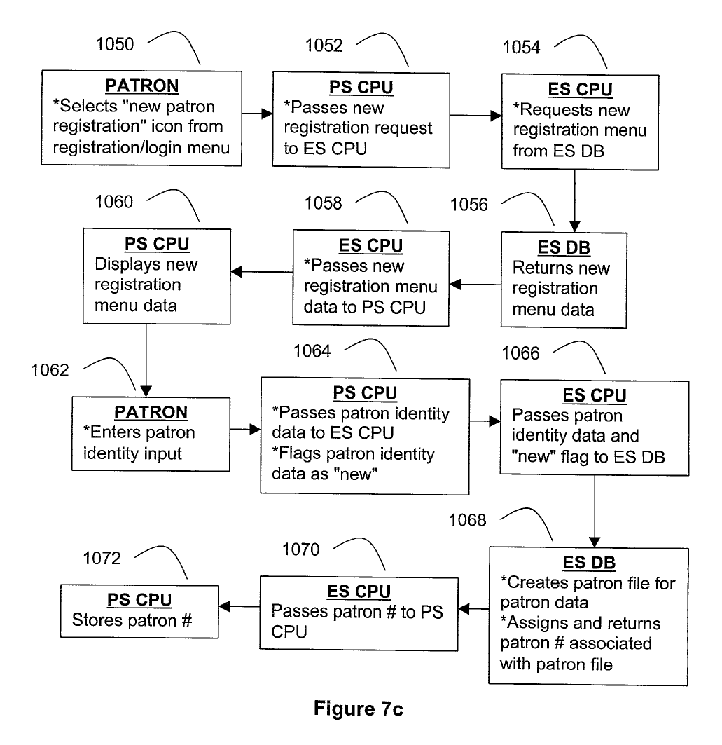

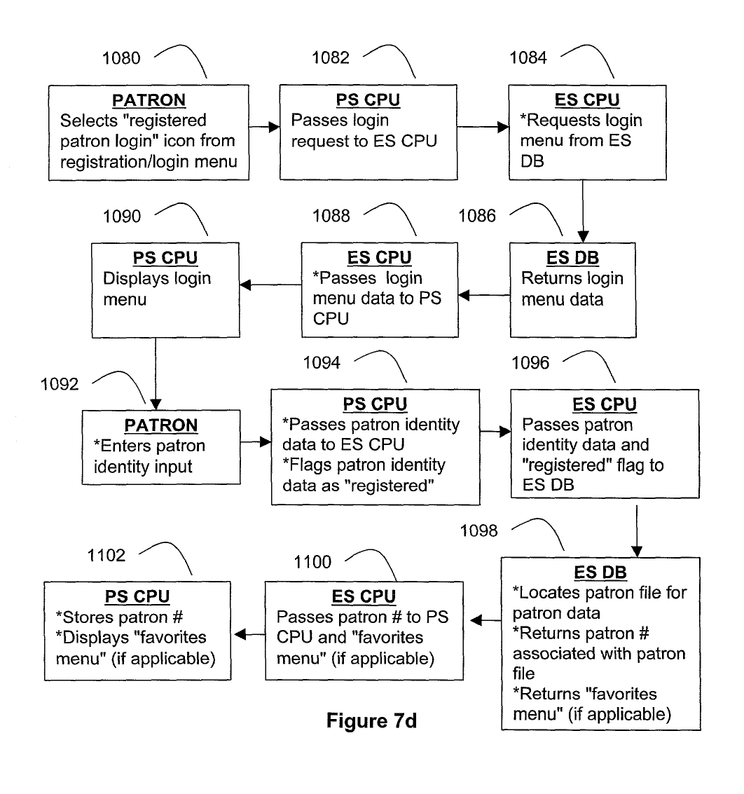

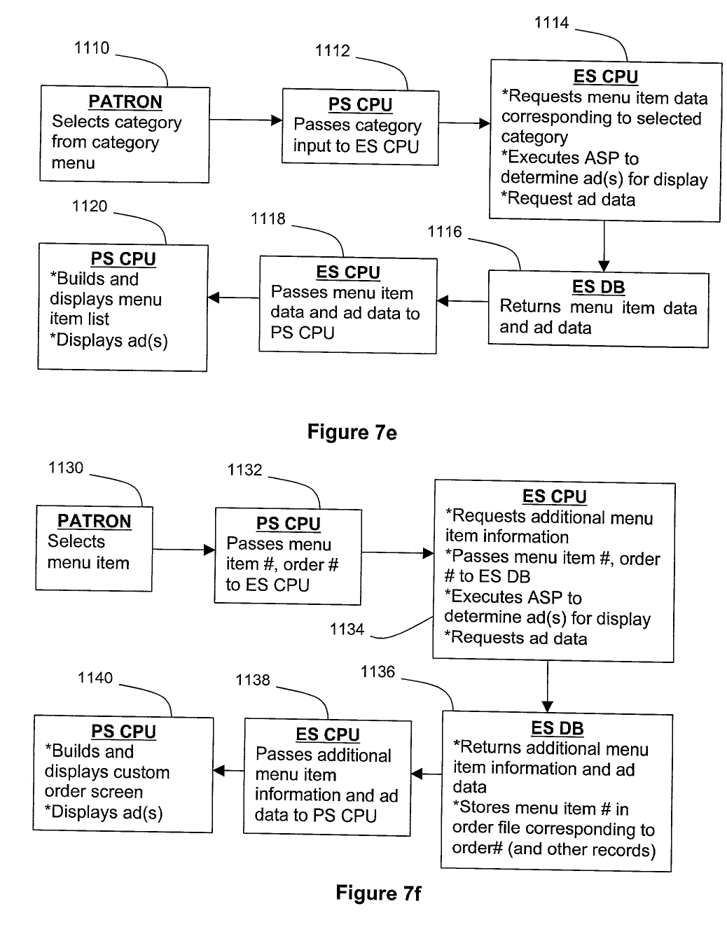

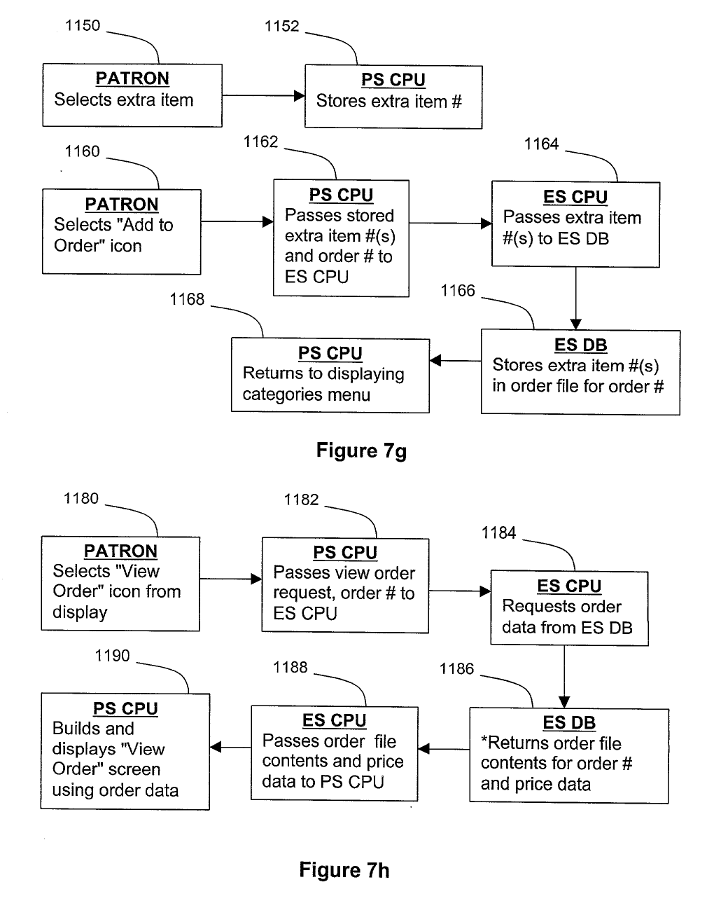

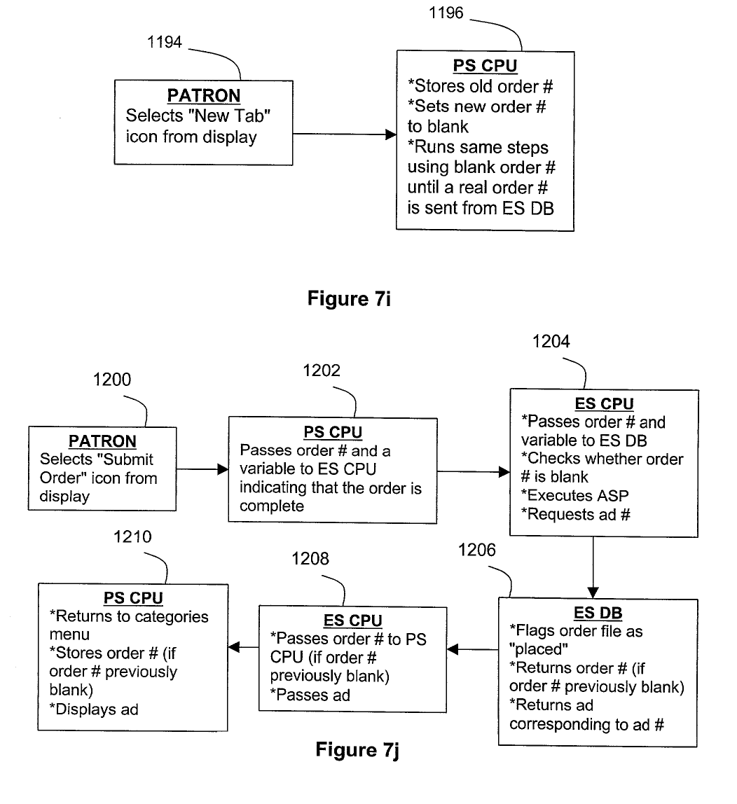

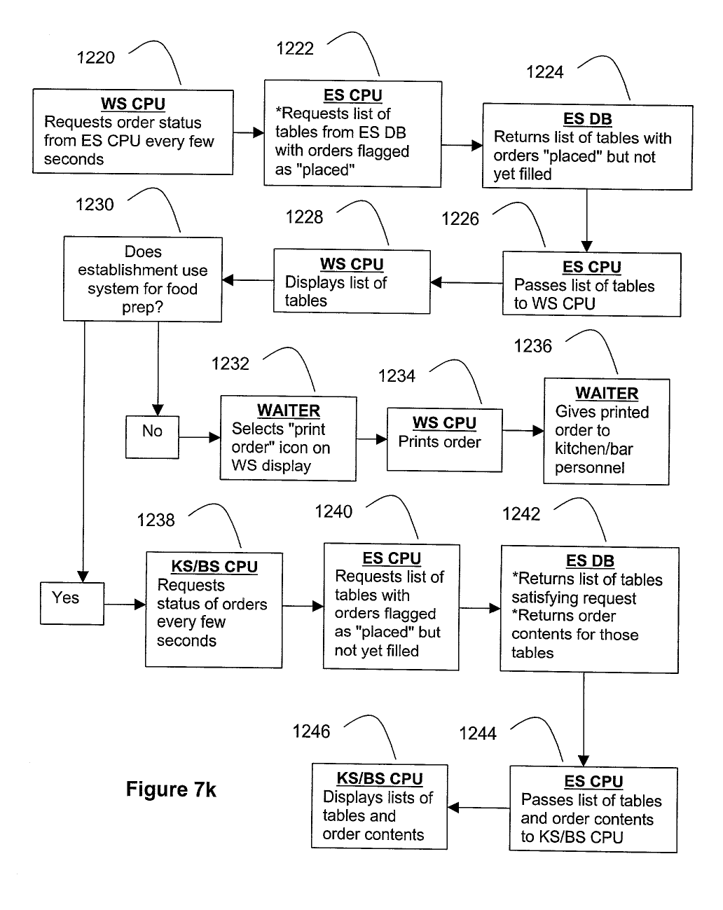

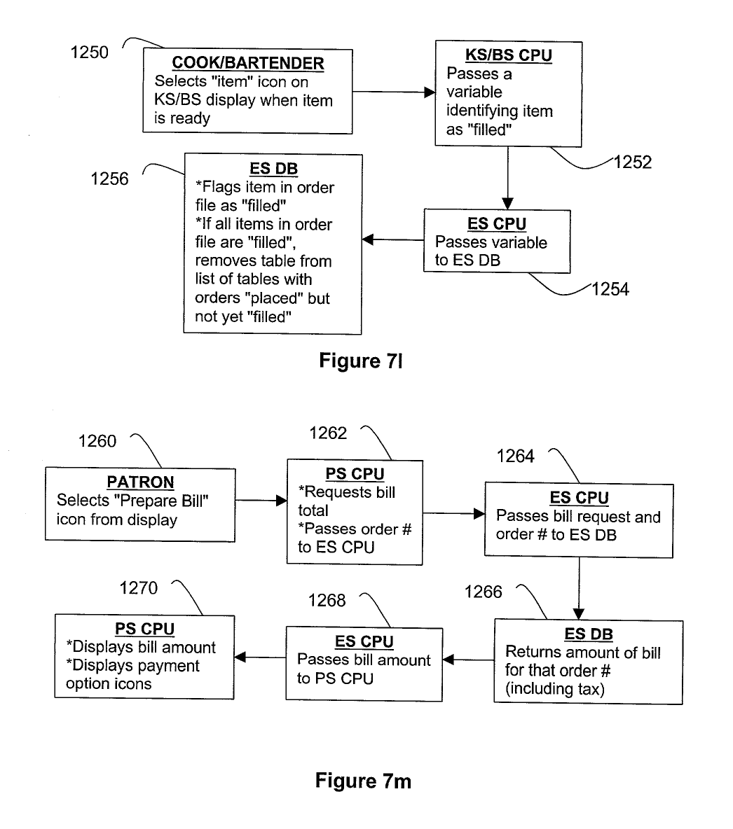

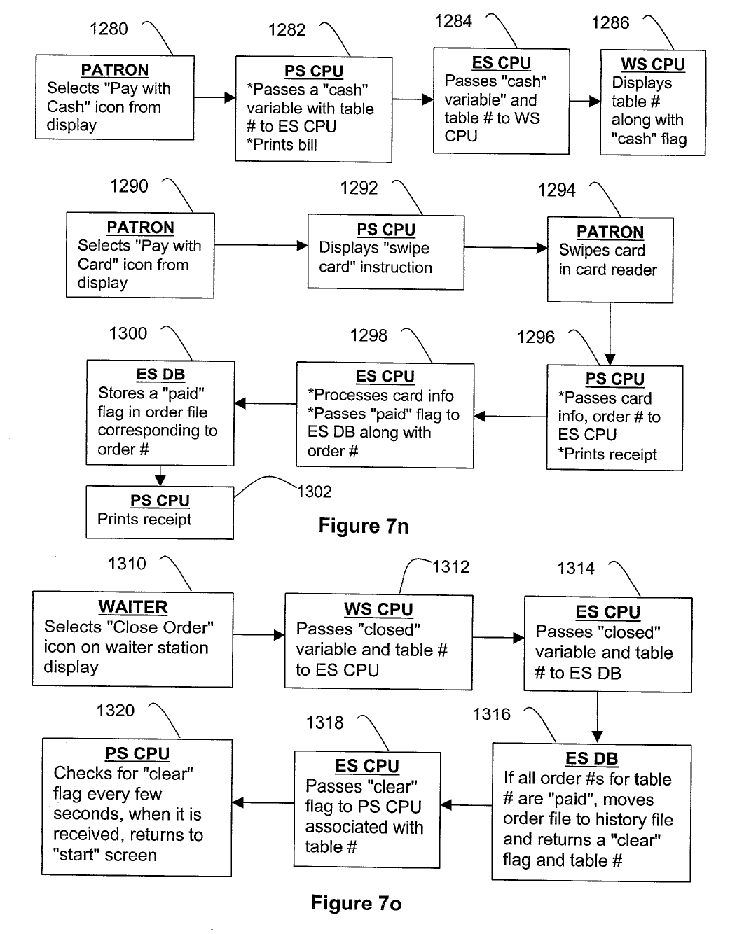

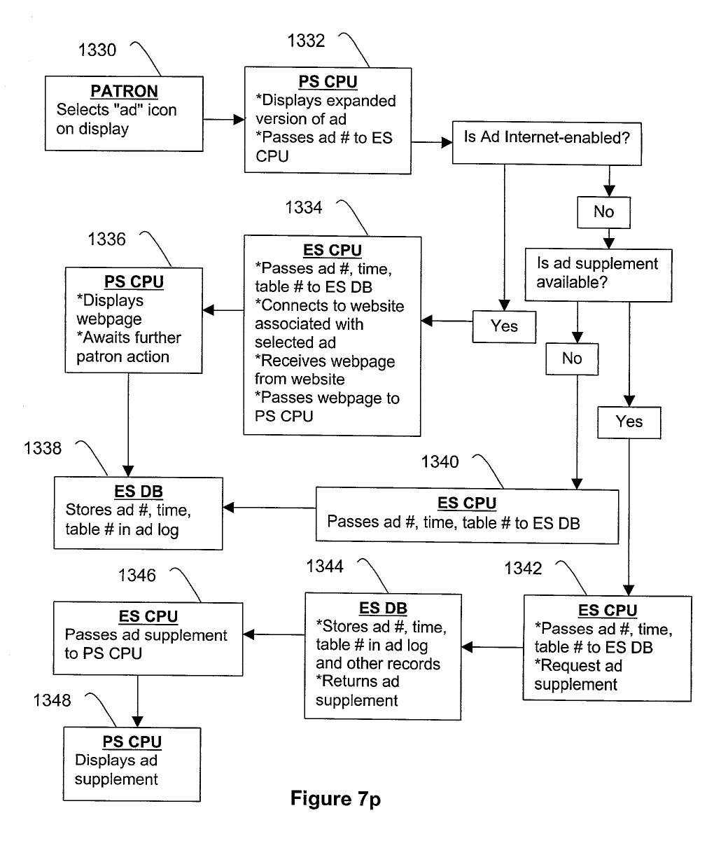

This disclosure will now address the operation of the invention with reference to FIGS. 7a through 7p which detail how the various components of the system handle different tasks.

Patron Seating

FIG. 7a illustrates a flowchart depicting how the system handles patron seating. At step 1000, the seater station CPU (SS CPU) requests from the establishment server a list of tables and their status. This request is periodically made, preferably every few seconds. The table status will either be “seated” or “available”. After receiving the request from the SS CPU, the establishment server CPU (ES CPU) will request, at step 1002, table data from the establishment server database (ES DB). At step 1004, the ES DB will return a list of tables and their status to the ES CPU. The ES CPU will then pass this data to the SS CPU (step 1006). Once in receipt of the data, the SS CPU will cause the list of tables and their status to be displayed (step 1008).

Once the seater station displays an accurate list of tables and their status, the seater can select the table at which new patrons should be sat. The seater, at step 1010, can make such a selection by touching a table icon associated with an “available” table. Then, at step 1012, the SS CPU will pass the table number of the selected table to the ES CPU. Thereafter, the ES CPU passes the table number to the ES DB (step 1014) so that the ES DB can update its list of tables and their status (step 1016). After performing the update, the ES DB will return an updated list of tables and their status so that such updated data can subsequently be presented to the seater (steps 1018, 1020).

Patron Station Start-up, Patron Registration, and Ordering

FIG. 7b is a flowchart illustrating the steps involved in initializing a patron station. At step 1030, a patron touches a “start” icon shown on the display. Then, at step 1032, the patron station CPU (PS CPU) will initiate contact with the establishment server by sending its network ID thereto. The establishment server will assign a table number of other such table identifiers to the patron station and will pass a cookie back to the PS CPU (step 1034) which contains the table number. The patron station will store the cookie. Each time the patron station and establishment server transact with each other, the ES CPU will read the cookie to determine the patron station with which it is dealing.

The ES CPU then passes the table number and initial category request to the ES DB (step 1036). Additionally, the ES CPU executes its ASP to determine which ad should be provided to the patron station associated with the received table number. As a result of the ASP execution, the ES CPU will request an advertisement from the database using an ad number.

Thereafter, at step 1038, the ES DB creates an order file associated with the table number, assigns an order number to the order file, returns the order number to the ES CPU, and returns the initial category menu data to the ES CPU. Also, the ES DB will return the advertisement associated with the received ad number. The ES CPU then passes the advertisement, initial category menu data, and order number to the PS CPU (step 1040). The PS CPU then causes the advertisement and initial category menu to be displayed (step 1042).

Depending upon the number of features supported by the establishment's system, the initial category menu can present several options. Preferably, the establishment supports patron registration. Using patron registration, the establishment server can remember registered patrons as well as their ordering preferences. By remembering known patron's preferences, these preferences can be offered to that patron upon his/her return. An example of a preferred initial categories menu is shown in FIG. 8. FIG. 8 depicts several categories of menu items as well as icons that allow a patron to either register himself/herself with the system or login to the system.

FIG. 7c depicts how the system registers new patrons. At step 1050, a patron touches the “new patron registration” icon on the display. The registration request is then passed from the PS CPU to the ES CPU to the ES DB (steps 1052 and 1054). The ES DB then returns a patron identity menu to the ES CPU, which is, in turn, passed to the patron station for display thereon (steps 1056, 1058, 1060).

Thereafter, at step 1062, the patron enters patron identity input. For example, the patron identity menu can include a touchscreen “keypad” which allows a patron to enter his name. Alternatively, the card reader 130 can be configured to process “smart cards” which have stored thereon a wide array of information specific to the patron possessing the smart card. The PS CPU would read the data stored on the smart card to obtain the requisite patron identity data. Next, the PS CPU passes the patron identity data to the ES CPU, which in turn, provides the patron identity data to the ES DB (steps 1064 and 1066). The ES DB then checks a patron list to determine whether the data supplied by the patron has already been registered (whether the name has already been taken). In the event a new name is needed, an appropriate request can be routed back to the patron station. Upon receipt of unregistered patron identity data, the ES DB will add the patron identity data to the patron listing, create a patron file associated with the patron identity data, and return a patron number to the ES CPU (step 1068). Thereafter, at step 1070, the ES CPU passes the patron number to the patron station, which stores the patron number in its memory (step 1072). The patron station can then send this patron number with any orders from the patron station so that the ES DB can store a patron's order history in his/her patron file. Further, the data in a patron's file can be used to develop a “favorites menu” which can be presented to the patron during subsequent uses of the system. The “favorites menu” may comprise the menu items commonly ordered by that particular patron.

FIG. 7d depicts how the system logs in registered patrons. At step 1080, a patron touches “registered patron login” icon on the display. The login request is then passed from the PS CPU to the ES CPU to the ES DB (steps 1082 and 1084). The ES DB then returns a patron identity menu to the ES CPU, which is in turn, passed to the patron station for display thereon (steps 1086, 1088, 1090).

Thereafter, at step 1092, the patron enters patron identity input. For example, the patron identity menu can include a touchscreen “keypad” which allows a patron to enter his name. Next, the PS CPU passes the patron identity data to the ES CPU, which in turn, provides the patron identity data to the ES DB (steps 1094 and 1096). The ES DB then checks a patron list to find the patron number associated with that patron identity. In the event that no patron number matching the patron identity data is found, a request can be routed back to the patron station asking the patron to reenter data. Upon locating the patron number matching the patron identity data, the ES DB will return that patron number to the ES CPU (step 1098). Thereafter, at step 1100, the ES CPU passes the patron number to the patron station, which stores the patron number in its memory (step 1102) for subsequent use in tracking the patron's orders. If there is a stored “favorites menu” in the patron file, then step 1098 may include returning the “favorites menu” data to the ESCPU for subsequent display on the patron station.

After registration is complete, the patron station will redisplay the initial categories menu (or possibly a “favorites menu”). FIG. 7e is a flowchart illustrating how the system processes menu selections. At step 1110, a patron touches a category icon on the display. The PS CPU then, at step 1112, passes the category input to the ES CPU, along with any stored variables (such as the table number, order number, and patron number, which can collectively be referred to as tracking numbers). In turn, the ES CPU passes the received variables to the ES DB and requests menu item data corresponding to the selected category from the database (step 1114). Also, the ES CPU can then execute the ASP to determine the ad number of the ad that is to be displayed on the patron station. Thereafter, at step 1116), the ES DB will update the appropriate files (order file, patron file) with the category data, return the menu item data corresponding to the category selection, and return the ad to be displayed. Then, the menu item data and ad data is passed from the ES CPU to the PS CPU for display on the patron station display (steps 1118 and 1120).

FIG. 7f depicts a flowchart illustrating how the system processes menu item selections. Steps 1130 through 1140 shown in FIG. 7f mirror those shown in FIG. 7e. It should also be noted that, depending upon the depth of the establishment's menu (number of different categories of menu items, etc), the steps of FIGS. 7e and 7f may be repeated as need to allow a patron to reach a menu that offers specific menu items.

Once a patron has made a selection of a menu item, the patron station will display a “customize order” screen (see step 1140 of FIG. 7f). FIG. 7g illustrates how a patron may customize his/her order. From the “customize order” screen, a patron may select extra items (i.e., mustard and onions on a hamburger), and the PS CPU will store an extra item number(s) corresponding to the patron's selection(s) (steps 1150 and 1152). Then, at step 1160, the patron can finalize his/her customization by touching an “add to order” icon. At this point, the PS CPU passes its stored extra item number(s) to the ES CPU along with any stored tracking numbers (step 1162). The ES CPU then passes the extra item number(s) and tracking numbers to the ES DB (step 1164). The ES DB then updates the order file (and patron file, if applicable) with the extra item data (step 1166). Thereafter, the patron station returns to the categories menu (step 1168).

FIG. 7h illustrates how a patron may view his order. At step 1180, a patron touches a “view order” icon on the display. The PS CPU then passes this view order request to the ES CPU along with the stored order number (step 1182). The ES CPU then, at step 1184, uses that information to request order information from the database. In turn, the ES DB returns to the ES CPU the order data found in the order file corresponding to the order number (step 1186) and the ES CPU passes this data back to the PS CPU (step 1188). Thereafter, the patron station displays the order contents (step 1190).

FIG. 7i illustrates how the system processes a request from the patron to start a new tab during the same session. Upon receiving a “new tab” request from a patron at step 1194, the PS CPU uses a blank order number when initially processing the new tab. The same steps previously described in connection with FIGS. 7b-7e can be run, with the exception. that the ES DB, upon receiving a blank order number, will assign a new order number to be associated with the table number, and return the new order number to the patron station for storage thereon (collectively shown as step 1196). The patron can then select whether additional orders should be applied to the old order number or the new order number.

Order Submission and Order Processing

FIG. 7j illustrates the order submission process for the invention. At step 1200, the patron touches the “submit order” icon on the display, which causes the PS CPU to pass its stored variables (order number, patron number, table number) to the ES CPU along with a flag indicating that the order is complete (step 1202). Then, at step 1204, the ES CPU passes the order number and other variables to the ES DB along with the “complete” flag. Additionally, the ES CPU can execute the ASP to determine the ad number of the ad to be shown on the patron station display. Further, the ES CPU will check whether the order number is blank (indicating that the patron has requested a new tab). In the event that the order number is found to be blank, the ES CPU can request a new order number from the ES DB. In response to the requests from the ES CPU, the ES DB will (1) flag the order file corresponding with the order number as “placed”, (2) create an order file and return an order number (if the order number was previously blank), and return the ad corresponding to the ad number found as result of the ASP execution (step 1206). The ES CPU will then, at step 1208, pass the order number back to the PS CPU (if the order number was previously blank) and pass the returned ad back to the PS CPU. The PS CPU will return to the initial categories menu, display the ad, and store the order number if necessary (step 1210). Thus, the database will now have stored therein an order file identifying the contents of an order placed by a patron.

Meanwhile, as shown in FIG. 7k, the waiter station CPU (WS CPU) will periodically request the status of orders for each table from the ES CPU, preferably every few seconds (step 1220). In response to the request from the WS CPU, the ES CPU will request from the ES DB a list of tables and the contents of the order files flagged as “placed” associated with each table number (step 1222). The ES DB will then return the list of tables with “placed” orders that are not yet “filled” as well as the contents of those orders (step 1224). In turn, the ES CPU passes this data to the WS CPU (step 1226), and the WS CPU displays that data (step 1228) to thereby allow waiters and waitresses to learn the orders which need to be taken to their tables.

At this point, further steps in the process will depend upon whether the establishment also uses a kitchen station or a bar station. In the event that the establishment does not use a kitchen station or a bar station, the waiter/waitress will select a “print order” icon on the waiter station display to obtain a printed copy of the order which can then be passed to the appropriate personnel for fulfillment of the order (steps 1232, 1234, and 1236). For example, the waiter will hand a copy of the order to the cook so the cook will know what food needs to be prepared.

In the event that the establishment does use a kitchen station and a bar station, the kitchen station and/or bar station CPU (KS/BS CPU) will periodically request the status of orders for each table from the ES CPU, preferably every few seconds (step 1238), much the same way the WS CPU does. In response to the request from the KS/BS CPU, the ES CPU will request from the ES DB a list of tables and the contents of the order files flagged as “placed” associated with each table number (step 1240). The ES DB will then return the list of tables with “placed” orders that are not yet filled as well as the contents of those orders (step 1242). In turn, the ES CPU passes this data to the KS/BS CPU (step 1244), and the KS/BS CPU displays that data (step 1246) to thereby allow cooks and/or bartenders to learn the orders which need to be prepared.

Turning to FIG. 71, once an item has been prepared, the cook/bartender will then touch an “item” icon on the display to indicate that item is ready (step 1250). Then, at step 1252, the KS/BS CPU will pass a variable to the ES CPU identifying that one of the items in the order is “ready”, and the ES CPU will pass this variable to the ES DB (step 1254). Then, at step 1256, the ES DB will flag the item in the order file as “filled”. If all items in the order are filled, the ES DB will flag the entire order as “filled” and remove that table/order from the list of tables/orders that have been placed but not filled. Because of this change in status for the order, when the WS CPU issues its order status request (step 1220 of FIG. 7k), the waiter station will learn of the orders ready to be taken to the tables when the updated files are read from the ES DB.

FIG. 7m illustrates the bill preparation and payment process. At step 1260, the patron touches a “prepare bill” icon on the display. The PS CPU then passes this request along with the tracking numbers to the ES CPU which passes the same on to the ES DB (steps 1262 and 1264). The ES DB returns the bill amount for the order (step 1266) and the payment options menu data. Preferably, the ES DB will include the tax in the returned data. The ES CPU will then pass the bill amount and payment options menu data back to the PS CPU (step 1268) causing the PS CPU to display the bill amount and payment options menu to the patron (step 1270).

Turning to FIG. 7n, if the patron wishes to pay using cash, he/she will touch a “pay with cash” icon (step 1280), which causes the PS CPU to pass a “cash” variable to the ES CPU along with the tracking numbers (step 1282). The ES CPU then passes this data on to the WS CPU (step 1284) which causes the WS CPU to display an indication that the patron wishes to pay with cash. The waiter/waitress will then be alerted to go to the table and collect payment. Either at step 1282 or 1286, the bill can be printed at the patron station or waiter station depending upon how the system is designed.

If the patron wishes to pay using a credit card, he/she will touch a “pay with card” icon on the patron station (step 1290). The PS CPU will display a “swipe card” instruction (step 1292), and the patron will swipe his/her credit/debit card through the patron station's card reader (step 1294). The patron station then passes the card data along with the tracking numbers to the ES CPU (step 1296), which processes the card data and (if processing is successful) passes a “paid” flag to the ES DB and a “print” command to the PS CPU (step 1298). In the event card processing is unsuccessful, the patron station can reinstruct the patron to swipe his/her card. At step 1300, the ES DB will flag the order file as “paid”, and at step 1302, the PS CPU will print a receipt for the patron to sign.

It is worth noting that in communicating the bill to the patron and then collecting payment, the system can be configured to either automatically include a tip or allow a patron to enter a selected tip amount into the system, which would relieve the patron of the burden of calculating an appropriate tip (for example, calculating 15% or 20% of the bill amount).

Thereafter, as shown in FIG. 7o, to close out the ordering session for that table, the waiter/waitress can touch a “close order” icon shown on the waiter station (step 1310). The WS CPU will passes the “closed variable” to the ES CPU along with the order number (step 1312), and the ES CPU will pass this data to the ES DB (step 1314). Then at step 1316, if all order numbers for that table are flagged as “paid”, then the ES DB moves the order files corresponding to those order numbers to various history files and returns a “clear” variable. Then, the ES CPU passes this “clear” variable to the appropriate patron station (step 1318). Meanwhile, at step 1320, the PS CPU will periodically check for a “clear” flag every few seconds, and when one is received, the PS CPU will return to the start screen and delete its stored order number(s) and patron number(s).

Additional Features

FIG. 7p illustrates how the system can allow a patron to learn more about a particular advertisement displayed on the patron station. Each advertisement icon shown on the patron station display is preferably selectable by the patron. Upon selection, the patron can either be linked to the advertiser's website, or an advertisement supplement can be shown to the patron. The advertisement supplement may contain more detailed information about the goods or services shown in the advertisement. Also, an enlarged version of the advertisement can be shown on the patron station display. Further still, to allow an advertiser to collect feedback on the effectiveness of advertisements, any ad selections made by a patron can be recorded in an ad log stored on the establishment server database.

As shown in FIG. 7p, a patron touches an ad icon at step 1330. At step 1332, the patron station displays an enlarged version of the selected ad and passes the ad number to the ES CPU along with the tracking numbers. At this point, the ES CPU will determine whether the ad is internet-enabled and if not whether there is an ad supplement associated with the selected ad stored in the ES DB.

If the ad is internet-enabled, at step 1334, the ES CPU will pass the ad number, time, and tracking numbers to the ES DB so that the ES DB can update its records. Also, the ES CPU will connect to a website associated with the advertisement and cause the patron station to show this website (step 1336). At step 1338, the ES DB will update its records. In particular, an ad log detailing the selection history of each ad will be updated.

If the ad is not internet-enabled and no ad supplement is available, at step 1340, the ES CPU will send the ad number, time, and tracking numbers to the ES DB so that the ES DB can update its records (step 1338).

If the ad is not internet-enabled, but an ad supplement is available, at step 1342 the ES CPU will pass the ad number and tracking numbers to the ES DB and request the ad supplement associated with the ad number from the ES DB. After the ES DB has updated its records and returned the ad supplement to the ES CPU at step 1344, the ES CPU will pass the ad supplement to the patron station (step 1346) which will cause the patron station to display the ad supplement (1348).

Further still, the present invention can be configured to allow a patron to purchase the goods or services shown in advertisements presuming that the provider of such goods and services is capable of taking on-line orders. A patron may enter a purchase request for an item shown in an ad, and the ES CPU can route appropriate ordering information to the provider over the network.

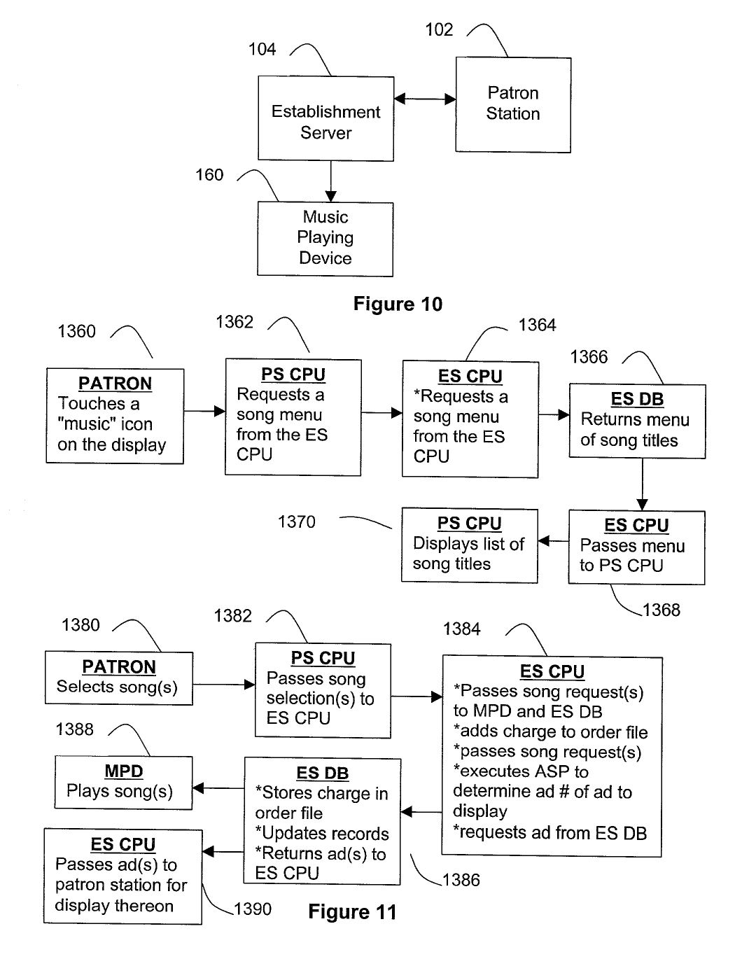

Also, FIGS. 10 and 11 illustrate how the present invention can be interfaced with a music playing device having a plurality of selectable music items (i.e., a jukebox having several songs to choose from) to allow a patron to play songs on the music playing device without leaving the table. When this feature is incorporated into the present invention, the advertising provided to a patron station can further be tailored according to a patron's taste in music. As a result, a music company wishing to target its new releases to particular consumers can use the present invention to locate and deliver advertisements to patrons who have selected a song on the music playing device that is similar to the type of music on the new release.

As shown in FIG. 10, the establishment server 104 is coupled to a music playing device 160, which can be a jukebox or the like. When input is received at a patron station 102 corresponding to a selection of one of the songs on the music playing device 160, the establishment server 104 can take this song request and send a signal to the music playing device 160 that is operative to initiate the playing of that song.

FIG. 11 shows how this process can be carried out. At step 1360, the patron touches a “music” icon on the patron station display. At step 1362, the PS CPU passes a request for a song menu to the ES CPU, which in turn, requests the song menu from the ES DB (step 1364). To support this feature, it is preferred that the ES DB store a current list of the songs available on the music playing device 160. The ES DB then returns the song menu (step 1366) which is passed back to the PS CPU by the ES CPU (step 1368) for display thereon (step 1370).

After having found a song (or songs) that he/she wishes to hear, the patron can select that song(s) at step 1380. Thereafter, at step 1382, the PS CPU passes the song request to the ES CPU. Then, at step 1384, the ES CPU can (1) pass the song request to the music playing device 160 and ES DB, (2) add an appropriate charge to the order file of the patron, (3) execute the ASP to determine the ad number of the ad to display on the patron station, and (4) request that ad from the ES DB. At step 1386, the ES DB will (1) store the charge in the patron's order file, (2) update the appropriate records with the song selection data (patron file, order file), and (3) return the requested ad. At step 1388, the music playing device will play the requested song, and at step 1390, the ad will be passed to the patron station for display thereon.

Another valuable feature of the present invention is that the data stored in the establishment server database can be a gold mine of demographic information. The ad logs, order files, and patron files stored in the establishment server database may be of extreme interest to advertisers and marketing people. The ad log will be a repository of the ads selected by patrons and can be used to gauge the effectiveness of an advertisement. The patron file will be a record of specific patrons' food/drink and ad interests (as well as music taste). The order file will be a record of the popularity of an establishment's various foods/drinks. Using this information, an advertiser can intelligently design an advertising scheme that will effectively reached targeted consumers.

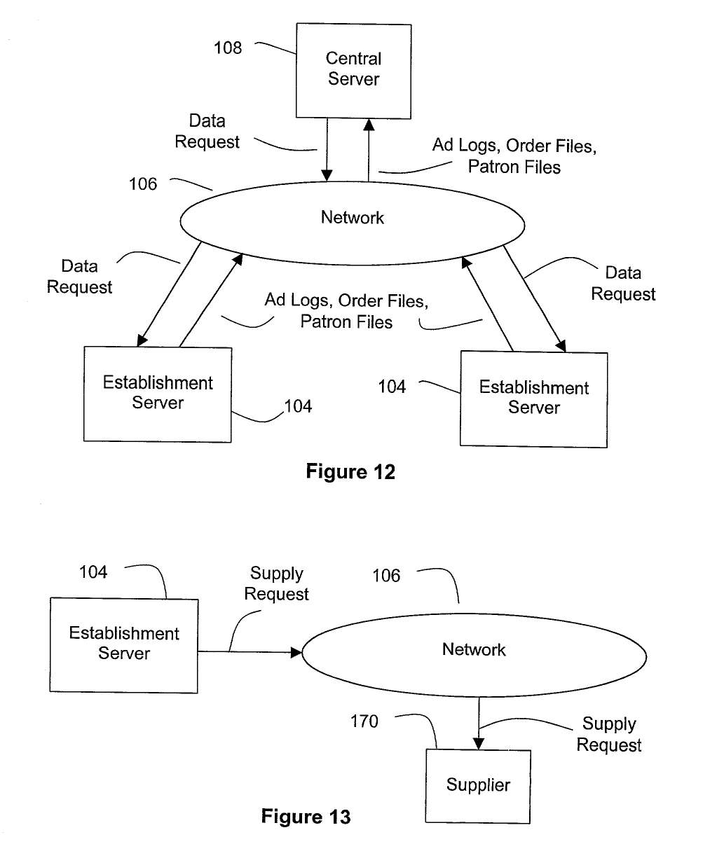

FIG. 12 illustrates how an advertiser/marketer can harvest this gold mine of demographic information. The central server can collect the records of each establishment server it supports, and thus serve as a centralized source for demographic information. The central server 108 can issue a data request over network 106 to any and all of the establishment servers 104 with which it is in communication. In response to receiving a data request, each establishment server can send over network 106 to central server 108 any and all of the following records: ad logs, order files, and patron files. Once the central server 108 is in receipt of these records, an advertiser/marketer can analyze them to develop an effective advertising scheme.

To further enhance the demographic records maintained by the establishment server database, the system can prompt patrons to enter demographic information about themselves into the patron stations. To provide such incentive, an establishment can offer a reward (i.e., a free dessert, appetizer, etc.) in return for entering the information. An advertiser/marketer may be willing to reimburse the establishment owner for the costs of such a reward program. Also, one of the staff-related stations (i.e., the waiter station or seater station) can be configured to allow establishment staff to enter demographic information about the patrons (i.e., an estimated age, gender, race, manner of dress, etc). This information can be compiled in the order files and patron files to further enhance the quality of the demographic information maintained by the database.

Yet another feature of the present invention is the present invention's ability in connection with supply tracking. If the establishment server database maintains a record of the establishment's supply of various menu items (i.e., 200 hamburgers, 12 cases of Beer X), the system can be used to detect whether a new supply of a menu item is needed because the system allows a record to be kept of menu items that are ordered. Thus, as shown in FIG. 13, if the establishment server determines that a new supply of a menu item is needed, a supply request can be sent from the establishment server 104 over network 106 to a supplier 170 of that menu item. Once in receipt of the supply request, the supplier 170 can initiate the process of fulfilling the establishment's request.

Further, the flexibility of the present invention's advertising scheme can allow an establishment owner to defray the cost of purchasing or leasing the system through the use of localized advertising. The administrator of the central server can set aside some advertising rights to the establishment owner, who may then solicit his/her own advertisements. For example, a local butcher shop may want to advertise on the patron stations located in a steak restaurant. The owner of the steak restaurant can solicit such advertising from the butcher and then share in the revenue derived from the local ad. If an establishment owner is capable of soliciting enough local advertising, the revenue from local advertising received by the establishment owner may cover the costs involved in purchasing or leasing the present invention. It is preferred that such local advertisements be installed onto the system from the central server as previously described in connection with other advertisements, which would allow the central server administrator to maintain a high degree of control over the advertising aspect of the system. However, the administration station 110 located in an establishment (which presumably would be a PC located in the back office of an establishment used by an owner/manager for administrative tasks such as accounting) can have software installed thereon allowing it to interface directly with the establishment server to install local ads on the establishment server database and make appropriate modification's to that establishment server's ASP.

It is believed that the present invention, by incorporating an effective advertising scheme into an interactive ordering system, will provide the difference that allows the present invention to succeed where prior art interactive ordering systems have failed. Further, it is to be understood that the above-described embodiments of the present invention are merely illustrative of the principles thereof and that numerous modifications and embodiments of the invention may be derived within the spirit and scope thereof. For example, the embodiment disclosed herein illustrates how various tasks are assigned to different components of the invention. However, although it would be less preferred due to perceived inefficiencies in operational speed and predicted costs, many of the processing tasks assigned to the establishment server can be performed by the various patron stations or even the central server. Also, data storage tasks can be shifted to the patron stations or the central server. As such, the true spirit and scope of the invention is to be determine from the claims below with reference to the above disclosure, the figures, and the knowledge of a person of ordinary skill in the art.

What is claimed is:

1. A patron service system for serving at least one patron of an establishment, said system comprising:
at least one patron station located in said establishment and configured to electronically display a plurality of menu items and electronically display at least one advertisement thereon, each patron station also being configured to receive order input from a patron corresponding to an order of at least one of said menu items; and
an establishment server in communication with each patron station, said establishment server being configured to receive and process said order input for later fulfillment of said order.

2. The system of claim 1 wherein said establishment server further includes a data base for storing a plurality of advertisements, and wherein said establishment server is further configured to select at least one advertisement from said plurality of stored advertisements, and communicate said at least one advertisement to each patron station for display thereon.

3. The system of claim 1 wherein said establishment server further includes means for changing the content of said advertising data base.

4. The system of claim 2 wherein said establishment server further comprises a processor and a stored program executed by said processor for selecting which advertisement is communicated to each patron station for display.

5. The system of claim 4 further comprising a central server in communication with a plurality of said establishment servers, said central server being configured to communicate a plurality of advertisements to each of said establishment servers for storage in their respective advertising data bases.

6. The system of claim 5 wherein said central server is further configured to communicate at least portions of said stored program to each of said establishment servers, said portions of said stored program being determinative of a methodology for selecting advertisements from the data base for communication to and display on each of said patron stations.

7. The system of claim 5 wherein each of said patron stations is further configured to receive demographic information from a patron and communicate said demographic information to said establishment server.

8. The system of claim 7 wherein said central server includes a database and wherein each of said establishment servers is further configured to accumulate and communicate demographic information to said central server for accumulation into said central server data base.

9. The system of claim 4 wherein said advertisement selection program is further configured to select at least one advertisement from said plurality of advertisements stored in said advertising data base to communicate to a patron station for display at least partially in response to a particular order input.

10. The system of claim 4 wherein said advertisement selection program is further configured to select at least one advertisement from said plurality of advertisements stored in said advertising data base to communicate to a patron station for display at least partially in response to a particular time of day.

11. The system of claim 15 wherein each patron station is further configured to (1) receive patron identity input from a patron corresponding to that patron's identity and (2) communicate said patron identity input to said establishment server, and wherein said advertisement selection program is further configured to select at least one advertisement from said plurality of advertisements stored in said advertising data base to communicate to a patron station for display at least partially in response to a particular patron identity input.

12. The system of claim 5 wherein each patron station is further configured to (1) receive advertisement selection input from a patron corresponding to a selection of an advertisement displayed thereon and (2) communicate said advertisement selection input to said establishment server for further processing thereby.

13. The system of claim 12 wherein said establishment server is further configured to store a plurality of advertisement supplements thereon, each advertisement supplement being associated with an advertisement stored in said advertising data base, said establishment server being further configured to communicate said advertisement supplement associated with a particular advertisement to a particular patron station for display thereon in response to that particular patron station receiving advertisement selection input corresponding to a selection of that particular advertisement.

14. The system of claim 12 wherein said establishment server is further configured to link a particular patron station to a website associated with a particular advertisement in response to that particular patron station receiving advertisement selection input corresponding to a selection of that particular advertisement.

15. The system of claim 12 wherein said establishment server is further configured to (1) store data corresponding to said advertisement selection input in an advertisement selection record, and (2) communicate said advertisement selection record to said central server.

16. The system of claim 2 wherein each patron station is further configured to (1) receive patron identity input from a patron corresponding to that patron's identity and (2) communicate said patron identity input to said establishment server for further processing thereby.

17. The system of claim 16 wherein said establishment server is further configured to create and store thereon a patron file for each different patron identity, said patron file identifying at least one menu item ordered by said patron corresponding to said patron identity.

18. The system of claim 17 wherein said establishment server is further configured to communicate each patron file to said central server.

19. The system of claim 17 wherein each patron station is further configured to (1) receive advertisement selection input from a patron having a patron file, said advertisement selection input corresponding to a selection of an advertisement displayed thereon and (2) communicate said advertisement selection input to said establishment server, and wherein said establishment server is further configured to store said advertisement selection input in said patron file corresponding to said patron from which said advertisement selection input was received.

20. The system of claim 5 wherein said establishment server is further configured to (1) store data corresponding to said order input in an order record, and (2) communicate said order record to said central server.

21. The system of claim 5 wherein said establishment server is also in communication with a music playing device having a plurality of selectable music items and configured to play any of said music items upon selection, wherein each patron station is further configured to receive music selection input corresponding to a selection of at least one of said music items, and wherein said establishment server is further configured to send a signal to said music playing device operative to initiate the playing of each selected music item in response to said music selection input.

22. The system of claim 21 wherein said establishment server is further configured to store said music selection input in a music selection record and communicate said music selection record to said central server.

23. The system of claim 21 wherein said establishment server is further configured to select at least one advertisement from said plurality of advertisements stored in said advertising data base to communicate to a patron station for display at least partially in response to a particular music selection input.

24. In an establishment having at least one patron station located therein, said patron station having a display on which a plurality of selectable menu items are electronically displayed, said patron station being configured to receive order input from a patron corresponding to an order of at least one of said menu items, said patron station also being in communication with an establishment server configured to receive and process said order input to enable subsequent fulfillment of said order, a method for delivering advertising to patrons of said establishment, said method comprising:
electronically displaying at least one advertisement on the display of each patron station.

25. The method of claim 24 further comprising:
storing a plurality of advertisements on said establishment server; and
selecting at least one of said stored advertisements for communication to each patron station for display thereon.

26. The method of claim 25 wherein said establishment has a plurality of said patron stations located therein, each patron station being in communication with said establishment server, said method further comprising:
for each patron station, selecting at least one advertisement to be communicated thereto from said establishment server by executing a program stored on said establishment server, said advertisement selection program comprising executable code corresponding to a plurality of conditions under which said advertisements are to be selected; and
communicating to each patron station the advertisement selected therefor.

27. The method of claim 26 wherein said establishment server is in communication with a central server by way of a network, said method further comprising:
receiving said plurality of advertisements on said establishment server from said central server via said network.

28. The method of claim 27 further comprising:
receiving at least a portion of said advertisement selection program on said establishment server from said central server via said network; and
storing said received advertisement selection program on said establishment server.

29. The method of claim 26 wherein said selecting step includes:
for each patron station, selecting at least one advertisement to be communicated thereto from said establishment server at least partially in response to said order input received by that patron station.

30. The method of claim 26 wherein said selecting step includes:
for each patron station, selecting at least one advertisement to be communicated thereto from said establishment server at least partially in response to a particular time of day.

31. The method of claim 26 wherein said selecting step includes:
for each patron station, selecting at least one advertisement to be communicated thereto from said establishment server at least partially in response to a predetermined condition.

32. The method of claim 26 wherein each patron station is further configured to receive patron identity input from a patron corresponding to a patron's identity, said method further comprising:
receiving patron identity input on at least one patron station; and
wherein said selecting step includes, for each patron station that received patron identity input, selecting at least one advertisement to be communicated thereto from said establishment server at least partially in response to said patron identity input received by that patron station.

33. The method of claim 26 wherein each patron station is further configured to receive advertisement selection input corresponding to a selection of a particular advertisement displayed thereon, said method further comprising:
storing a plurality of advertisement supplements on said establishment server, each advertisement supplement being associated with an advertisement stored thereon;
receiving advertisement selection input on at least one patron station; and
electronically displaying said advertisement supplement associated with said particular advertisement corresponding to said advertisement selection input on the display of the particular patron station that received said advertisement selection input.

34. The method of claim 26 wherein each patron station is further configured to receive advertisement selection input corresponding to a selection of a particular advertisement displayed thereon, said method further comprising:
receiving advertisement selection input on at least one patron station;
connecting said establishment server to a website associated with a sponsor of the particular advertisement corresponding to said advertisement selection input; and
communicating said website to the patron station that received said advertisement selection input for display thereon.

35. The method of claim 27 wherein each patron station is further configured to receive advertisement selection input corresponding to a selection of a particular advertisement displayed thereon, said method further comprising:
receiving advertisement selection input on a plurality of patron stations;
storing data corresponding to said received advertisement selection input in an advertisement selection record; and
communicating said advertisement selection record to said central server via said network.

36. The method of claim 27 wherein said establishment server is in communication with a music playing device having a plurality of selectable music items and configured to play any of said music items upon selection, and wherein each patron station is configured to receive music selection input corresponding to a selection of at least one of said music items, said method further comprising:
receiving music selection input on at least one patron station; and
sending a signal from said establishment server to said music playing device operative to initiate the playing of said selected music item.

37. The method of claim 36 further comprising:
storing data corresponding to said music selection input in a music selection record; and
communicating said music selection record to said central server via said network.

38. The method of claim 36 wherein said selecting step includes, for each patron station that received said music selection input, selecting at least one advertisement to be communicated thereto from said establishment server at least partially in response to said music selection input received by that patron station.

39. The method of claim 27 wherein each patron station is further configured to receive patron identity input corresponding to a patron's identity, said method further comprising:
receiving patron identity input on at least one patron station;
storing data corresponding to said patron identity input in a patron record; and
communicating said patron record to said central server via said network.

40. The method of claim 39 wherein each patron station is further configured to receive advertisement selection input corresponding to a selection of a particular advertisement, said method further comprising:
receiving advertisement selection input on said patron stations from a plurality of patrons;
associating said advertisement selection input with each patron from which it was received; and
storing data corresponding to said advertisement selection input in said patron record for said patron associated therewith.

41. The method of claim 27 wherein said establishment server is also in communication with an establishment server input device, said method further comprising:
receiving patron identity input corresponding to a patron's identity on said establishment server input device from an authorized user;
storing data corresponding to said patron identity input in a patron record; and
sending said patron record to said central server via said network.

42. The method of claim 27 further comprising:
storing data corresponding to said order input in an order record;
communicating said order record to said central server via said network.

43. The method of claim 42 wherein each patron station is further configured to receive advertisement selection input corresponding to a selection of a particular advertisement displayed thereon, said method further comprising:
receiving advertisement selection input on said patron stations from a plurality of patrons;
associating said advertisement selection input with an order also received on the patron station that received said advertisement selection input; and
storing data corresponding to said advertisement selection input in said order record for said order associated therewith.

44. The method of claim 27 further comprising:
storing inventory data on said establishment server, said inventory data corresponding to a supply of at least one of said menu items;
updating said inventory data at least partially in response to said received order inputs; and
determining at least partially from said inventory data whether an additional amount of said menu item corresponding to said inventory data is needed.

45. The method of claim 44 further comprising:
upon a determination being made that an additional amount of said menu item corresponding to said inventory data is needed, communicating a supply request over said network to a computer associated with a provider of said needed menu item and configured to receive and process said supply request.

46. In a system comprising a central server connected to a network, a plurality of establishment servers also connected to said network, and a plurality of patron stations, each establishment server being associated with at least one establishment, each patron station being connected to the establishment server associated with the establishment within which that patron station is located, each patron station having a display on which a plurality of selectable menu items and a plurality of advertisements are electronically displayed, each patron station being configured to receive order input corresponding to an order of at least one of said menu items, each establishment server being configured to store a plurality of advertisements thereon and communicate at least one of said stored advertisements to each patron station connected thereto for subsequent display on said patron station display, each establishment server also being configured to receive and process any order input received by each patron station to which it is connected to thereby enable subsequent fulfillment of such orders, a method of controlling the advertisements displayed on the patron station displays of each patron station, said method comprising:
for each establishment server, communicating thereto for storage thereon a plurality of advertisements from said central server.

47. The method of claim 46 further comprising:
for each establishment server, communicating thereto for storage and execution thereon an advertisement selection program from said central server, each advertisement selection program comprising a plurality of rules defining a plurality of conditions under which said advertisements are to be displayed on the display of each patron station connected to that establishment server.

48. In an establishment having at least one patron station located therein, said patron station having a display on which a plurality of selectable menu items are electronically displayed, said patron station being configured to receive order input from a patron corresponding to an order of at least one of said menu items, said patron station also being. in communication with an establishment server configured to receive and process said order input to enable subsequent fulfillment of said order, said establishment server also being configured to communicate a plurality of advertisements stored thereon to said patron station for display on said patron station display, a method of controlling the advertisements displayed on said patron station display, said method comprising:
selecting an advertisement stored on said establishment server at least partially in response to a predetermined condition;
communicating said selected advertisement from said establishment server to said patron station; and
electronically displaying said selected advertisement on said patron station display.

49. The method of claim 48 wherein said selecting step includes:
associating an advertisement with a particular type of order input; and
selecting said associated advertisement at least partially in response to said type of order input being received by said patron station.

50. The method of claim 48 wherein said selecting step includes:
associating an advertisement with a particular time of day;
determining the time of day; and
selecting said associated advertisement at least partially in response to said time of day being determined.

51. The method of claim 48 further comprising:
storing an advertisement selection program on said establishment server, said advertisement selection program defining a plurality of conditions under which each advertisement is to be selected; and
wherein said selecting step includes executing said advertisement selection program to thereby select an advertisement.

52. The method of claim 48 wherein said patron station is further configured to receive patron identity input corresponding to a patron's identity, said method further comprising receiving patron identity input on said patron station, and wherein said selecting step includes (1) associating an advertisement with a particular type of patron identity input and (2) selecting said associated advertisement at least partially in response to said type of patron identity input being received by said patron station.

53. The method of claim 48 wherein said establishment server is in communication with a music playing device having a plurality of selectable music items and being configured to play any of said music items upon selection, said patron station being further configured to receive music selection input corresponding to a selection of at least one of said music items, and said establishment server being further configured to send a signal to said music playing device operative to play said music item corresponding to said music selection input received by said patron station, said method further comprising receiving music selection input on said patron station, and wherein said selecting step includes (1) associating an advertisement with at least one of said music items, and (2) selecting said associated advertisement when music selection input corresponding to that music item is received by said patron station.

54. A patron service system for serving patrons located in a plurality of establishments, said system comprising:
a central server connected to a network;
a plurality of establishment servers, each establishment server being connected to said network and being associated with at least one establishment; and
a plurality of patron stations, each patron station being located in an establishment and being connected to the establishment server associated with the establishment within which that patron station is located;
wherein each patron station has a display on which a plurality of selectable menu items and at least one advertisement are electronically displayed;
wherein each patron station is configured to receive order input corresponding to an order of at least one of said menu items;
wherein each establishment server is configured to receive and process the order input received by each patron station connected thereto for subsequent fulfillment of each order;
wherein said central server is configured to communicate a plurality of advertisements to each establishment server over said network;
wherein each establishment server is further configured to store thereon the advertisements received from said central server; and
wherein each establishment server is further configured to communicate at least one of said advertisements stored thereon to each patron station connected thereto for subsequent display on thereon.

55. The system of claim 54 wherein each establishment server has stored thereon an advertisement selection program which upon execution is configured to select which of said stored advertisements are to be provided to which of said patron stations.

56. The system of claim 54 wherein said central server is further configured to communicate at least a portion of an advertisement selection program to each establishment server over said network.
